(19) United States
(12) Patent Application Publication
(10) Pub. No.: US 2025/0296459 A1
(43) Pub. Date: Sep. 25, 2025

(54) TRACTION INVERTER BASED AUTOMOTIVE AC ONBOARD CHARGER

(71) Applicant: Ford Global Technologies, LLC, Dearborn, MI (US)

(72) Inventors: Baoming Ge, Okemos, MI (US); Fan Xu, Novi, MI (US)

(21) Appl. No.: 18/610,903

(22) Filed: Mar. 20, 2024

(51) Int. Cl. B60L 53/24; B60L 53/22; H02M 7/5387

(52) U.S. Cl. CPC B60L 53/24; B60L 53/22; H02M 7/53871; B60L 2210/42

(57) ABSTRACT

During a charge mode of a vehicle, switches of a dual active bridge connected between a traction battery and an inverter system controller are deactivated, switches of the inverter system controller are deactivated, and other switches of the dual active bridge are operated such that electrical energy from a grid connected with the vehicle flows through the inverter system controller and a transformer of the dual active bridge to the traction battery without a motor connected with the inverter system controller generating torque.

### TECHNICAL FIELD

This disclosure relates to automotive power systems and the charging of automotive traction batteries.

### BACKGROUND

Hybrid vehicles (HEVs) and Battery Electric Vehicles (BEVs) feature electric systems. HEVs combine an internal combustion engine with an electric propulsion system, utilizing a battery that is recharged through regenerative braking and the engine. This dual system allows for reduced fuel consumption. BEVs, on the other hand, rely solely on electric power, with large-capacity batteries providing energy to one or more electric motors for propulsion. These vehicles incorporate advanced battery management systems, along with DC/DC converters to maintain electrical system stability. Both types integrate regenerative braking, converting kinetic energy into electrical energy for battery recharging.

### SUMMARY

A vehicle has a power system including a traction battery, a motor, an inverter system controller connected with the motor, and a dual active bridge, including a transformer, connected between the traction battery and inverter system controller. The vehicle also has a controller that, during a drive mode of the vehicle, activates switches of the dual active bridge such that electrical energy from the traction battery bypasses the transformer, flows through the inverter system controller, and to the motor, and during a charge mode of the vehicle, deactivates the switches such that electrical energy from a grid connected with the vehicle flows through the inverter system controller and the transformer to the traction battery without the motor generating torque.

A method includes, during a drive mode of a vehicle, activating switches of a dual active bridge connected between a traction battery and inverter system controller, and operating switches of the inverter system controller such that electrical energy from the traction battery bypasses a transformer of the dual active bridge, flows through the inverter system controller, and to a motor. The method also includes, during a charge mode of the vehicle, deactivating the switches of the dual active bridge, deactivating switches of the inverter system controller, and operating other switches of the dual active bridge such that electrical energy from a grid connected with the vehicle flows through the inverter system controller and the transformer to the traction battery without the motor generating torque.

A power system for a vehicle includes a traction battery, a motor, an inverter system controller connected with the motor, a dual active bridge, including a transformer, connected between the traction battery and inverter system controller, and a controller. The controller, during a charge mode of the vehicle, deactivates switches of the dual active bridge, deactivates switches of the inverter system controller, and operates other switches of the dual active bridge such that electrical energy from a grid connected with the vehicle flows through the inverter system controller and the transformer to the traction battery without the motor generating torque.

### BRIEF DESCRIPTION OF THE DRAWINGS

FIG. 1 is a schematic diagram of an on-board vehicle charger including a transformer.

FIG. 2 is a schematic diagram of an on-board vehicle charger including an inverter system controller.

FIG. 3 is a schematic diagram of an on-board vehicle charger including a dual active bridge and an inverter system controller.

FIG. 4A is a plot of simulated battery voltage associated with the on-board charger of FIG. 3.

FIG. 4B is a plot of simulated battery current associated with the on-board charger of FIG. 3.

FIG. 5A is a plot of simulated grid current and voltage associated with the on-board charger of FIG. 3.

FIG. 5B is a plot of simulated motor currents of phases associated with the on-board charger of FIG. 3.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

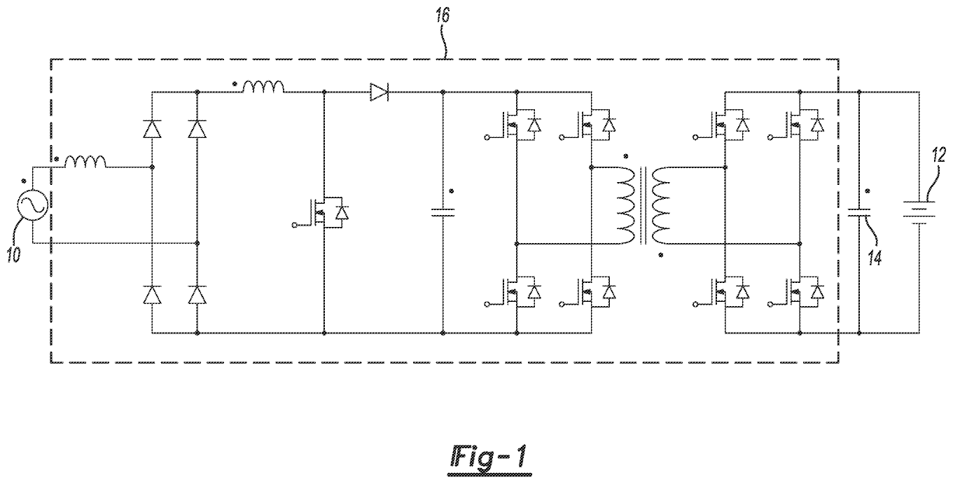

An AC on-board charger is a subsystem in certain electric vehicles and hybrid electric vehicles to charge a traction battery from an AC power grid. FIG. 1 shows an AC grid 10, a traction battery 12, a DC link capacitor 14, and a typical AC on-board charger 16. The DC link capacitor 14 is connected in parallel with the traction battery 12, between the traction battery 12 and AC on-board charger 16. The AC on-board charger 16 is connected between the AC grid 10 and DC link capacitor.

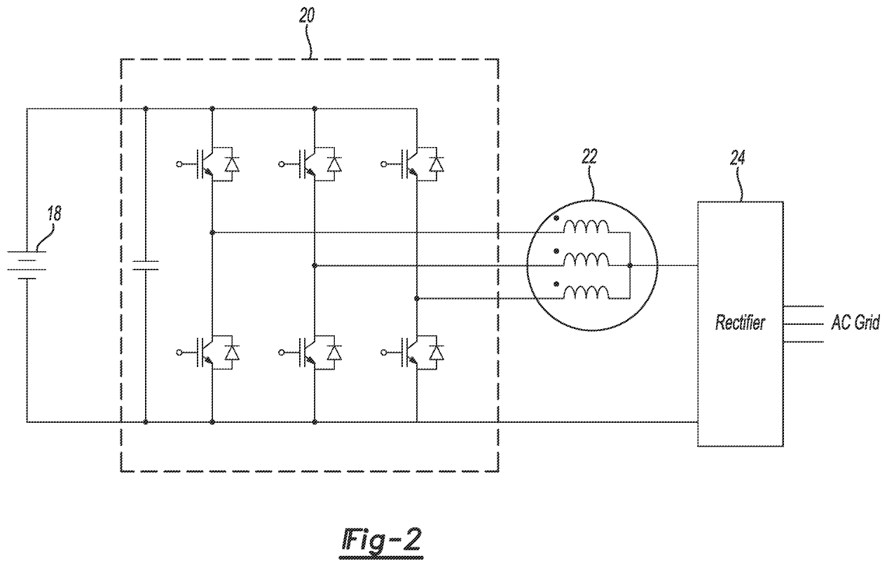

In some designs, the on-board charger is combined with the traction inverter and motor windings. FIG. 2 shows an example that includes a traction battery 18, an inverter system controller 20, a motor 22, and a rectifier 24. The inverter system controller 20 is connected between the traction battery 18 and motor 22. The motor 22 is connected between the inverter system controller 20 and rectifier 24. The motor windings are employed as an inductor and the inverter is employed as a boost converter. This arrangement may generate unintentional torque when current flows through the motor windings and requires the motor windings' neutral point be connected to the charger interface circuit. Also, this arrangement has no transformer isolation function.

Here, an architecture and associated control scheme are proposed to solve the torque and galvanic isolation issues mentioned with reference to FIG. 2, by integrating an AC on-board charger into a traction inverter. That is, an inverter system controller can be used to achieve an AC on-board charger. As will be apparent, no current will flow in motor windings during battery charging, so there will be no torque generated.

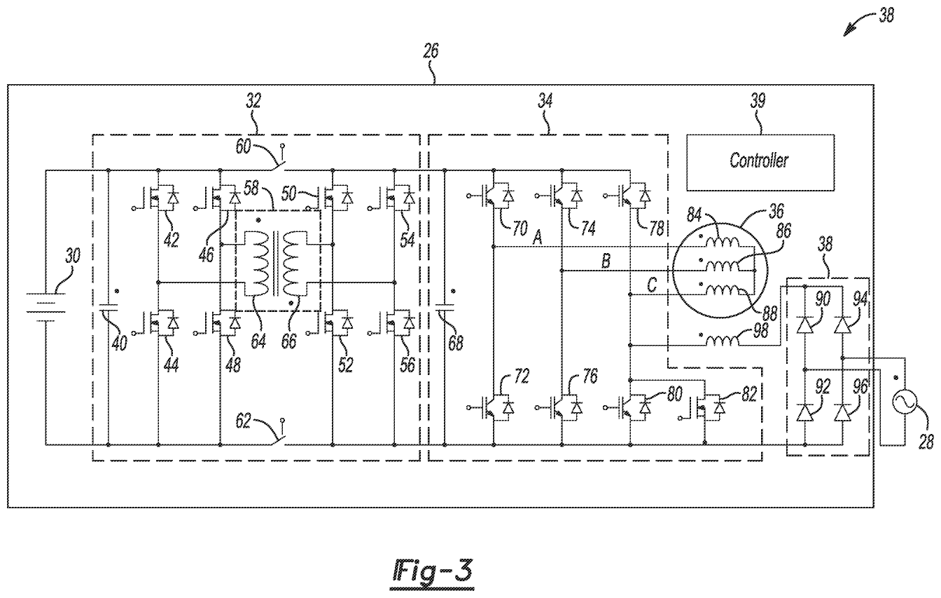

Referring to FIG. 3, a vehicle 26 is connected with an AC grid 28. The vehicle 26 includes a traction battery 30, a dual active bridge 32, an inverter system controller 34, a motor 36, a rectifier 38, and a controller 39. The dual active bridge 32 is connected between the traction battery 30 and inverter system controller 34. The inverter system controller 34 is connected between the dual active bridge 32 and motor 36 and rectifier 38. The rectifier 38 is connected between the inverter system controller 34 and grid 28.

The dual active bridge 32 includes a DC link capacitor 40, switches 42, 44, 46, 48, 50, 52, 54, 56, a transformer 58 (high-frequency transformer), and switches 60, 62. The DC link capacitor 40 is in parallel with the traction battery 30. The switches 42, 44 are in series, as are the switches 46, 48, the switches 50, 52, and the switches 54, 56. The DC link capacitor 40 is in parallel with the switches 42, 44 and the switches 46, 48. The transformer 58 is connected between the switches 42, 44, 46, 48 on one side, and the switches 50, 52, 54, 56 on the other side. The transformer 58 includes a pair of coils 64, 66. A first terminal of the coil 64 is connected between the switches 46, 48. A second terminal of the coil 64 is connected between the switches 42, 44. A first terminal of the coil 66 is connected between the switches 50, 52. A second terminal of the coil 66 is connected between the switches 54, 56. The switches 60, 62 are connected on rails of the dual active bridge 32 such that when closed, power does not flow through the transformer 58 and when open, power does flow through the transformer 58.

The inverter system controller 34 includes a capacitor 68 and switches 70, 72, 74, 76, 78, 80, 82. The switches 70, 72 are in series, as are the switches 74, 76, and the switches 78, 80. The capacitor 68 is connected between the switches 54, 56 and the switches 70, 72, and is in parallel with the switches 50, 52, the switches 54, 56, the switches 70, 72, the switches 74, 76, and the switches 78, 80. The switch 82 is in parallel with the switch 80.

The motor 36 includes windings 84, 86, 88. A first terminal of each of the windings 84, 86, 88 is connected between the switches 70, 72, the switches 74, 76, the switches 78, 80, respectively, thus defining three phases associated with the motor 36. Second terminals of each of the windings 84, 86, 88 are connected to define a neutral point of the motor 36.

The rectifier 38 includes diodes 90, 92, 94, 96. The diodes 90, 92 are in series, as are the diodes 94, 96. When attached, a first terminal of the grid 28 is connected between the diodes 90, 92, and a second terminal of the grid 28 is connected between the diodes 94, 96.

The vehicle 26 further includes an inductor 98. A first terminal of the inductor 98 is connected between the switches 78, 80. A second terminal of the inductor 98 is connected with the rectifier 38.

The switches 60, 62 can be contactors. The switches 70, 72, 74, 76, 78, 80 can be silicon insulated-gate bipolar transistors with integrated diodes or silicon carbide metal-oxide-semiconductor field-effect transistors with body diodes. The switch 82 can be a silicon carbide metal-oxide-semiconductor field-effect transistor with a body diode.

The switches 70, 72, 74, 76, 78, 80 perform the traction inverter function, and the switch 82 and the diode of the switch 78 perform the power factor correction function. The switches 70, 72, 74, 76, 78, 80 may have high current capability, the switch 82 may have low current capability but high switching frequency capability. Their gate drivers should account for these features. With high switching frequency of the switch 82, the size of inductor 98 can be relatively small.

When compared with the arrangement of FIG. 1, the arrangement of FIG. 3 integrates the power factor correction power switches into the traction inverter to save space. When compared with the arrangement of FIG. 2, the arrangement of FIG. 3 has no torque generated during battery charging mode and achieves transformer isolation, which is not provided for in the arrangement of FIG. 2.

The controller 39 is in communication with/exerts controls over the components of the vehicle 26 and implements the control strategies contemplated herein.

As shown in FIG. 3, during operation of the vehicle 26, the switches 60, 62 are closed, the switches 42, 44, 46, 48, 50, 52, 54, 56 are turned off, the switch 82 is turned off, and the AC grid 28 is not connected to the on-board charger formed by the dual active bridge 32, inverter system controller 34, rectifier 38, and inductor 98. The switches 70, 72, 74, 76, 78, 80 perform switching via standard techniques and drive the motor 36 to propel the vehicle 26. The traction battery 30 delivers power to the motor 36 and vehicle 26 through the inverter system controller 34 during motoring mode (a drive mode). Generated power is sent back to the traction battery 30 through the motor 36 and inverter system controller 34 during generating mode (a drive mode).

During AC on-board charging mode, the AC grid 28 is connected to the input of diode rectifier 38, the switches 60,62 are opened, and the switches 70, 72, 74, 76, 78, 80 are turned off. As apparent to those of ordinary skill, the switch 82, the diode of the switch 78, the inductor 98 and the rectifier 38 work together to achieve the power factor correction function to meet efficiency, power factor requirements, and standards for the AC power grid 28. The switches 42, 44, 46, 48, 50, 52, 54, 56 are controlled to boost voltage for charging the traction battery 30 using standard techniques. Here, the high-frequency transformer 58 has two functions: voltage boost and high voltage isolation.

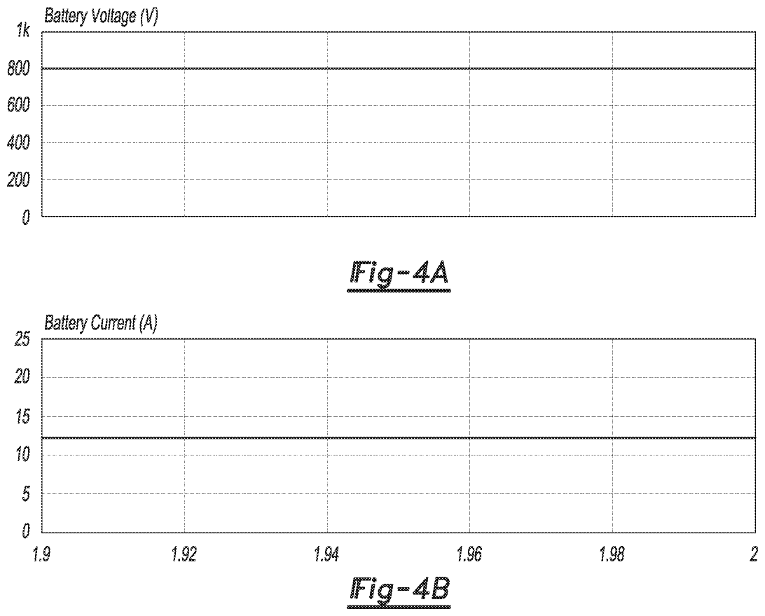

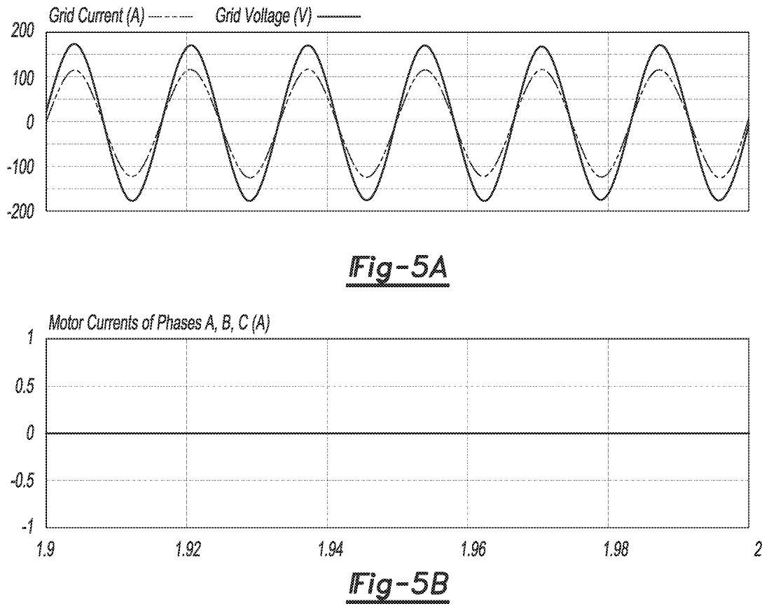

FIGS. 4A, 4B, 5A, and 5B show simulation results of the arrangement of FIG. 3 during AC charging. In simulation, the traction battery voltage is 800V (FIG. 4A) and 12.5 A battery current (10 kW) is charged into the traction battery 30 (FIG. 4B). The grid current of 83.5 A rms is in phase with the grid voltage, i.e., power factor is 1 (FIG. 5A). Motor phase currents are zero, so there is no torque generated (FIG. 5B).

The algorithms, methods, or processes disclosed herein can be deliverable to or implemented by a computer, controller, or processing device, which can include any dedicated electronic control unit or programmable electronic control unit. Similarly, the algorithms, methods, or processes can be stored as data and instructions executable by a computer or controller in many forms including, but not limited to, information permanently stored on non-writable storage media such as read only memory devices and information alterably stored on writeable storage media such as compact discs, random access memory devices, or other magnetic and optical media. The algorithms, methods, or processes can also be implemented in software executable objects. Alternatively, the algorithms, methods, or processes can be embodied in whole or in part using suitable hardware components, such as application specific integrated circuits, field-programmable gate arrays, state machines, or other hardware components or devices, or a combination of firmware, hardware, and software components.

While exemplary embodiments are described above, it is not intended that these embodiments describe all possible forms encompassed by the claims. Other topologies and variations are, of course, contemplated.

The words used in the specification are words of description rather than limitation, and it is understood that various changes may be made without departing from the spirit and scope of these disclosed materials. The terms “controller” and “controllers,” for example, can be used interchangeably herein as the functionality of a controller can be distributed across several such devices, which may all communicate via standard techniques.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A vehicle comprising:
a power system including a traction battery, a motor, an inverter system controller connected with the motor, and a dual active bridge, including a transformer, connected between the traction battery and inverter system controller; and
a controller programmed to, during a drive mode of the vehicle, activate switches of the dual active bridge such that electrical energy from the traction battery bypasses the transformer, flows through the inverter system controller, and to the motor, and during a charge mode of the vehicle, deactivate the switches such that electrical energy from a grid connected with the vehicle flows through the inverter system controller and the transformer to the traction battery without the motor generating torque.

2. The vehicle of claim 1, wherein the controller is further programmed to, during the drive mode, deactivate other switches of the dual active bridge, and operate switches of the inverter system controller.

3. The vehicle of claim 1, wherein the controller is further programmed to, during the charge mode, deactivate switches of the inverter system controller, and operate other switches of the dual active bridge.

4. The vehicle of claim 1, wherein the motor includes windings each connected with a phase leg of the inverter system controller.

5. The vehicle of claim 4, wherein terminals of the windings are connected to define a neutral point of the motor.

6. The vehicle of claim 1 further comprising a rectifier connected with the inverter system controller through an inductor.

7. The vehicle of claim 1, wherein the controller is further programmed to, during the charge mode, operate a switch of the inverter system controller to affect a power factor associated with the electrical energy from the grid.

8. A method comprising:
during a drive mode of a vehicle, activating switches of a dual active bridge connected between a traction battery and inverter system controller, and operating switches of the inverter system controller such that electrical energy from the traction battery bypasses a transformer of the dual active bridge, flows through the inverter system controller, and to a motor; and
during a charge mode of the vehicle, deactivating the switches of the dual active bridge, deactivating switches of the inverter system controller, and operating other switches of the dual active bridge such that electrical energy from a grid connected with the vehicle flows through the inverter system controller and the transformer to the traction battery without the motor generating torque.

9. The method of claim 8 further comprising, during the charge mode, operating another switch of the inverter system controller to affect a power factor associated with the electrical energy from the grid.

10. A power system for a vehicle, comprising:
a traction battery;
a motor;
an inverter system controller connected with the motor;
a dual active bridge, including a transformer, connected between the traction battery and inverter system controller; and
a controller programmed to, during a charge mode of the vehicle, deactivate switches of the dual active bridge, deactivate switches of the inverter system controller, and operate other switches of the dual active bridge such that electrical energy from a grid connected with the vehicle flows through the inverter system controller and the transformer to the traction battery without the motor generating torque.

11. The power system of claim 10, wherein the controller is further programmed to, during a drive mode of the vehicle, activate the switches of the dual active bridge and operate the switches of the inverter system controller such that electrical energy from the traction battery bypasses the transformer, flows through the inverter system controller, and to the motor.

12. The power system of claim 10, wherein the motor includes windings each connected with a phase leg of the inverter system controller.

13. The power system of claim 12, wherein terminals of the windings are connected to define a neutral point of the motor.

14. The power system of claim 10 further comprising a rectifier connected with the inverter system controller through an inductor.

15. The power system of claim 10, wherein the controller is further programmed to, during the charge mode, operate another switch of the inverter system controller to affect a power factor associated with the electrical energy from the grid.

16. The power system of claim 15, wherein the another switch has lower current capability than the switches of the inverter system controller.

17. The power system of claim 15, wherein the another switch has a higher switching frequency capability than the switches of the inverter system controller.
